(19) United States
(12) Patent Application Publication
(10) Pub. No.: US 2009/0232400 A1
(43) Pub. Date: Sep. 17, 2009

(54) IMAGE EVALUATION APPARATUS, METHOD, AND PROGRAM

(76) Inventor: Hajime Terayoko, Tokyo (JP)

Correspondence Address: BIRCH STEWART KOLASCH & BIRCH, PO BOX 747, FALLS CHURCH, VA, 22040-0747, US

(21) Appl. No.: 12/402,973

(22) Filed: Mar. 12, 2009

(30) Foreign Application Priority Data
Mar. 13, 2008 (JP) 063442/2008

(51) Int. Cl. G06K 9/46

(52) U.S. Cl. 382/195

(57) ABSTRACT

An image evaluation apparatus including a face detection unit for detecting, from an image including at least one face, each of the at least one face; a characteristic information obtaining unit for obtaining a plurality of characteristic information representing characteristics of each face; an expression level calculation unit for calculating an expression level representing the level of a specific expression of each face; and an evaluation value calculation unit for calculating an expression-based evaluation value for the image based on the characteristic information and the expression level of each face.

### BACKGROUND OF THE INVENTION

1. Field of the Invention

The present invention relates to an image evaluation apparatus and method for evaluating an image according to a face included in the image. The invention also relates to a computer readable recording medium on which is recorded a program for causing a computer to execute the image evaluation method.

2. Description of the Related Art

Along with the advancement of digital image analysis techniques, various types of expression recognition methods for not only detecting a face from an image but also recognizing the expression of the detected face are proposed. For example, a method for recognizing a facial expression by extracting contour positions of facial organs, such as the eye, mouth, and the like, constituting a face, and based on the openings of the contours of facial organs between the upper and lower ends thereof and curved state of each contour is proposed as described, for example, in Japanese Unexamined Patent Publication No. 2005-293539. Another method that obtains in advance a characteristic point of each facial organ of a face having a serious expression, surprised expression, or the like, and recognizes the expression of a face included in an inputted image based on the difference between the characteristic point of each facial organ of the face included in the inputted image and the characteristic point obtained in advance is proposed as described, for example, in Japanese Unexamined Patent Publication No. 2005-056388. Still another method that provides a plurality of learning data of faces having a specific expression and faces not having the specific expression, then using the learning data, performs learning for a discriminator to discriminate between the specific and non-specific expressions, and performs face recognition using the discriminator is proposed as described, for example, in Japanese Unexamined Patent Publication No. 2005-044330.

According to these methods, the level of specific expression (expression level) of a face is calculated, thus by outputting the expression level as a numeric value, the levels of expressions of faces included in an image, such as, levels of smiling, crying, and the like, may be obtained as numeric values.

The calculation of expression levels allows determination of superiority of individual faces included in an image, but does not allow superiority evaluation for the image.

The present invention has been developed in view of the circumstances described above, and it is an object of the present invention to enable not only the evaluation of a face included in an image but also the evaluation of the image.

### SUMMARY OF THE INVENTION

An image evaluation apparatus according to the present invention is an apparatus, including:

a face detection unit for detecting, from an image including at least one face, each of the at least one face;

a characteristic information obtaining unit for obtaining a plurality of characteristic information representing characteristics of each face;

an expression level calculation unit for calculating an expression level representing the level of a specific expression of each face; and

an evaluation value calculation unit for calculating an expression-based evaluation value for the image based on the characteristic information and the expression level of each face.

The term “a plurality of characteristic information” as used herein refers to information unique to each face, and more specifically, face orientation, face angle, and the like, as well as face position and face size, may be used as the information. Here, face orientation refers to the orientation of a face in the left or right, and face angle refers to the rotational angle of a face on the image plane.

In the image evaluation apparatus according to the present invention, the evaluation value calculation unit may be a unit for calculating the evaluation value by performing a weighted addition of the expression level of each face with a weighting factor determined based on the characteristic information corresponding to each face.

Further, in the image evaluation apparatus according to the present invention, the apparatus may further include an input unit for accepting input of a calculation basis for the evaluation value and the evaluation value calculation unit may be a unit for calculating the evaluation value using the inputted calculation basis.

Still further, in the image evaluation apparatus according to the present invention, when the weighting factor is a factor obtained by a weighted addition of evaluation points determined based on the plurality of characteristic information of each face with point weighting factors for weighting the evaluation points, the input unit may be a unit for accepting the calculation basis by accepting a instruction to change a point weighting factor, and the evaluation value calculation unit may be a unit for calculating the evaluation value by calculating the weighting factor with the changed point weighting factor.

Further, in the image evaluation apparatus according to the present invention, when the image is provided in a plurality and evaluation values are calculated for the plurality of images, the apparatus may further include a display unit for displaying an evaluation screen showing evaluation results according to the magnitude of the evaluation value of each image.

Still further, in the image evaluation apparatus according to the present invention, when the image is provided in a plurality and evaluation values are calculated for the plurality of images, the apparatus may further include a display unit for displaying an evaluation screen showing evaluation results according to the magnitude of the evaluation value of each image calculated with the inputted calculation basis.

An image evaluation method according to the present invention is a method including the steps of:

detecting, from an image including at least one face, each of the at least one face;

obtaining a plurality of characteristic information representing characteristics of each face;

calculating an expression level representing the level of a specific expression of each face; and

calculating an expression-based evaluation value for the image based on the characteristic information and the expression level of each face.

The image evaluation method according to the present invention may be provided as a program recorded on a computer readable recording medium for causing a computer to perform the method.

When evaluating an image, it is very important to consider not only the expression but also characteristic information, such as the size, position, and the like of each face included in the image. In view of this, the inventor of the present invention has come up with the present invention.

That is, according to the present invention, an expression-based evaluation value of an image is calculated based on the expression level of each face and a plurality of characteristic information representing characteristics of each face included in the image. This allows the superiority of the image, not the superiority of the face included in the image, to be determined easily based on the evaluation value of the image.

Further, the evaluation value may be calculated easily by performing a weighted addition of the expression level of each face with a weighting factor determined based on the characteristic information corresponding to each face.

Further, the evaluation value may be calculated according to the image evaluation criteria of the user desiring the evaluation by accepting input of a calculation basis for the evaluation value, and calculating the evaluation value using the inputted calculation basis.

Still further, where the weighting factor is a factor obtained by a weighted addition of evaluation points determined based on the plurality of characteristic information of each face with point weighting factors for weighting the evaluation points, an image evaluation value according to face characteristics desired by the user may be calculated by accepting the calculation basis through accepting an instruction to change a point weighting factor, and calculating the evaluation value with the changed point weighting factor.

Further, when the image is provided in a plurality and evaluation values are calculated for the plurality of images, the evaluation results of the plurality of images may be checked easily by displaying an evaluation screen showing evaluation results according to the magnitude of the evaluation value of each image.

In particular, by displaying an evaluation screen showing evaluation results according to the magnitude of the evaluation value of each image calculated with the inputted calculation basis, evaluation results of the plurality of images according to the inputted calculation basis may be checked easily.

### BRIEF DESCRIPTION OF THE DRAWINGS

FIG. 1 is a schematic block diagram of the image evaluation apparatus according to a first embodiment of the present invention, illustrating a schematic configuration thereof.

FIG. 2 is a drawing for explaining characteristic information.

FIG. 3 is a drawing for explaining calculation of a point with respect to the position of a face.

FIG. 4 is a flowchart of processing performed in the first embodiment.

FIG. 5 illustrates an evaluation screen in the first embodiment.

FIG. 6 illustrates an alternative evaluation screen in the first embodiment.

FIG. 7 is a flowchart of processing performed in a second embodiment.

FIG. 8 is a flowchart of preprocessing performed in the second embodiment.

FIG. 9 illustrates the configuration of face information database DB2.

FIG. 10 illustrates an evaluation screen in the second embodiment (example 1).

FIG. 11 illustrates an evaluation screen in the second embodiment (example 2).

FIG. 12 illustrates an evaluation screen in the second embodiment (example 3).

FIG. 13 illustrates an evaluation screen in the second embodiment (example 4).

### DESCRIPTION OF THE PREFERRED EMBODIMENTS

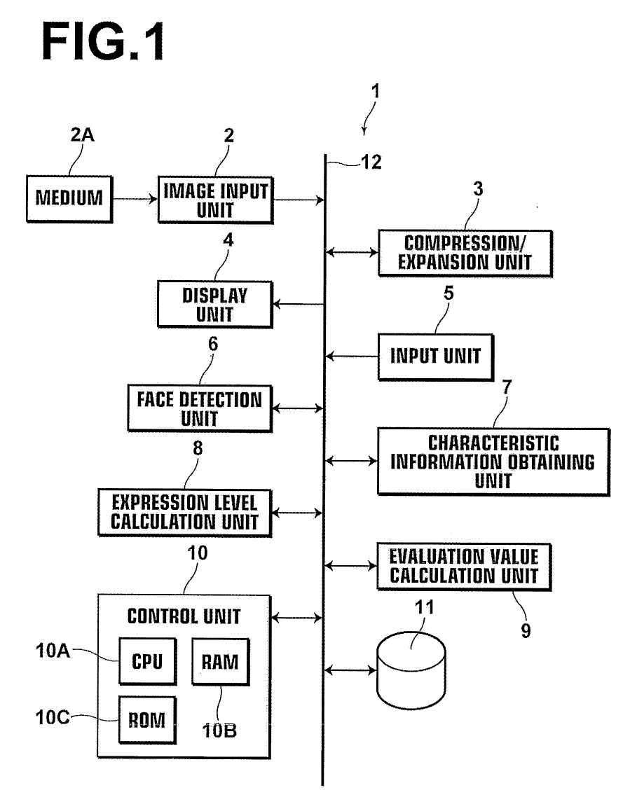

Hereinafter, embodiments of the present invention will be described with reference to the accompanying drawings. FIG. 1 is a schematic block diagram of the image evaluation apparatus according to a first embodiment of the present invention, illustrating a schematic configuration thereof. In the present embodiment, image evaluation is performed according to an expression of a face included in an image and, more specifically, according to a smiling level representing the level of smiling of the face included in the image.

As shown in FIG. 1, image evaluation apparatus 1 according to the present embodiment includes image input unit 2, compression/expansion unit 3, display unit 4 of a liquid crystal display or the like for displaying various information including an image, and an input unit 5 having a keyboard, a mouse, and the like for inputting various instructions to apparatus 1.

Image input unit 2 is a unit for inputting data representing an evaluation target image to image evaluation unit 1, which is a target of evaluation performed by image evaluation unit 1, and any of known devices may be used for this purpose, such as a media drive for reading out image data from a medium having the image data recorded thereon, a wire or wireless interface for receiving image data via a network, and the like. In the present embodiment, image input unit 2 is assumed, as an example case, to be a unit for reading out image data from medium 2A.

Image data are compressed by a compression method, such as JPEG compression method, so that the image data inputted from image input unit 2 are expanded by compression/expansion unit 3 before being processed.

Image evaluation apparatus 1 further includes face detection unit 6, characteristic information obtaining unit 7, expression level calculation unit 8, evaluation value calculation unit 9, control unit 10, and storage unit 11 for storing various types of information.

Face detection unit 6 detects a rectangular region enclosing a face (face region) as a face from an evaluation target image represented by the image data expanded by compression/expansion unit 3 by a template matching method, a method using a discriminator obtained by machine learning using a multiple of face sample images, or the like. The face detection method is not limited to this and any method may be used, such as a method that detects a rectangular region having a skin color in an image and enclosing a facial contour shape as a face, a method that detects a region of an image having a facial contour shape as a face, or the like. Where a plurality of faces is included in an evaluation target image, each of them is detected.

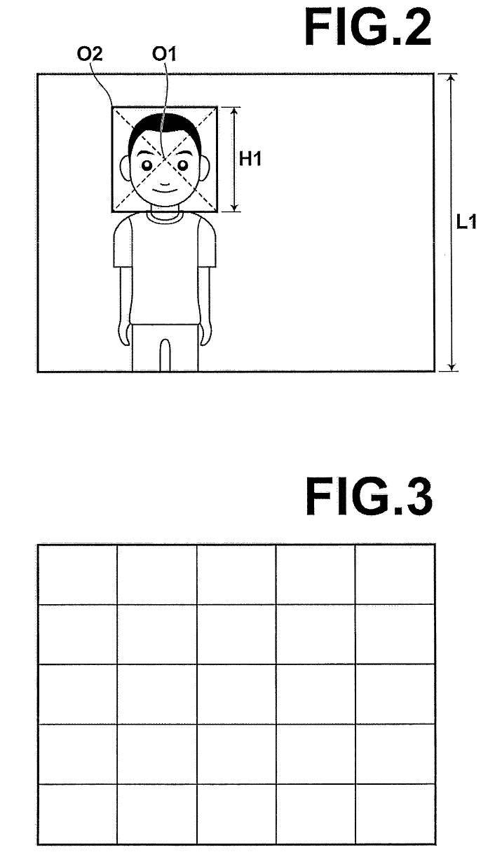

Characteristic information obtaining unit 7 obtains, with respect to a face detected by face detection unit 6, the position, size, orientation, and inclination of the face as characteristic information C. Here, the face position refers to the coordinate position of the intersection point of diagonal lines of the face region in the evaluation target image (point O1 in FIG. 2). It is noted that the coordinate position of the upper left corner of the face region (point O2 in FIG. 2) may be used as the face position.

As for the face size, the number of pixels in the face region, the ratio of the area of the face region to the area of the entire image, the ratio of one side of the face region to the short side of the image, or the like may be used. As shown in FIG. 2, in the present embodiment, one side (H1) of the face region to the short side (L1) of the evaluation target image, H1/L1, is obtained as information of the face size.

The face orientation refers to the orientation of the face in the left or right which may be obtained by determining whether the both eyes or either one of them is included in the image. For a front oriented face, information of face orientation angle may also be obtained according to the positions of the left and right eyes with respect to the position of the nose. Alternatively, it is possible to obtain a characteristic amount representing face orientation from a face and to determine the face orientation angle using the characteristic amount.

The face inclination refers to the rotation angle of the face on the plane of the image which, when both eyes are included in the image, may be obtained by calculating the angle of a line connecting the eyes to the horizontal direction of the image. Where only either one of the eyes is included, the face inclination can not be calculated, thus characteristic information C does not include the face inclination information. In the present embodiment, it is assumed that the face inclination value increases in the clockwise direction with the face in upright state being 0 degree.

Expression level calculation unit 8 obtains face characteristic amounts Q from a face detected by face detection unit 6. More specifically, it obtains characteristic amounts C required for calculating the smiling level, including contours of face components constituting the face, such as the eye, nose, and mouth, and positions of the face components, such as the positions of the inner and outer corners of the eyes, nostrils, mouth corners, and lips. Here, characteristic amounts Q may be obtained by a template matching method using templates of the respective face components, a method using discriminators for the respective face components obtained by machine learning using a multiple of sample images of face components, or the like.

Then, expression level calculation unit 8 calculates the expression level representing the level of a specific expression of the face based on obtained characteristic amounts Q. In the present embodiment, it calculates smiling level S representing the level of smiling of the face. As for the method for calculating the smiling level, for example, a method that calculates smiling level S according to the differences in positions and shapes of obtained characteristic amounts with respect to characteristic amounts Q_{full} and Q₀ obtained from a full smiling face and a non-smiling face respectively. The method for calculating the smiling level is not limited to this, and various known methods may be used, including the methods described in Japanese Unexamined Patent Publication Nos. 2005-293539, 2005-056388, and 2005-044330.

Evaluation value calculation unit 9 calculates smiling level S-based evaluation value T for the evaluation target image based on characteristic information C and smiling level S obtained with respect to each face included in the evaluation target image. More specifically, evaluation value T is obtained based on Formula (1) below.

T=ΣSi·Pi (1)

where, i is the number of faces included in the evaluation target image, Si is the smiling level of i^{th} face included in the evaluation target image, and Pi is the weighting factor determined based on characteristic information C of i^{th} face. A method for calculating weighting factor Pi will now be described.

In the present embodiment, it is assumed that the position, size, orientation, and inclination of a face are obtained as characteristic information C, and weighting factor P is calculated by Formula (2) below.

P=W1·R1+W2·R2+W3·R3+W4·R4 (2)

where, R1 to R4 are evaluation points for the position, size, orientation, and inclination of the face determined according to a predetermined rule, and W1 to W4 are weighting factors for weighting the points for the position, size, orientation, and inclination of the face respectively (point weighting factors).

Here, if a face included in the image locates closer to the center, the image is deemed more preferable. For this reason, in the present embodiment, the evaluation target image is divided into 25 regions as shown in FIG. 3, and point R1 for the face position is determined according to the location of the detected face. For example, point R1 for the face position is determined like 100 points if the face locates in the center region, 50 points if it locates in one of eight regions around the center, and 10 points if it locates in one of the most outer regions.

If a face included in the image is larger, the image is deemed more preferable. For this reason, in the present embodiment, point R2 is determined such that a greater value is given to a greater face size. Point R2 may be determined in a stepwise manner according to the face size or by multiplying a coefficient predetermined for the face size. Further, if the face size is smaller than a predetermined size, point R2 may be 0 point.

If a face included in the image is oriented more in the front direction, the image is deemed more preferable. For this reason, in the present embodiment, point R3 is determined such that a greater value is given to a face oriented more in the front direction. Point R3 may be determined in a stepwise manner according to the face orientation angle or by multiplying a coefficient predetermined for the face orientation angle. Further, if the face is oriented in a side direction, point R3 may be 0 point. Still further, where determination is made only as to whether the face is oriented in the front direction or in a side direction as the face orientation, point R3 may be 100 points if the face is oriented in the front direction and 0 point if the face is oriented in the side direction.

If a face included in the image is less inclined, the image is deemed more preferable. For this reason, in the present embodiment, point R4 is determined such that a greater value is given to a face with inclination closer to 0 degree. Point R4 may be determined in a stepwise manner according to the face inclination angle or by multiplying a coefficient predetermined for the face inclination angle. Further, if the face inclination is in the range from 90 to 270 degrees, point R4 may be 0 point.

It is noted that each of weighting factors W1 to W4 has a predetermined value.

Control unit 10 includes CPU 10A, RAM 10B used as the work area when various types of processing is performed, and ROM 10C having stored therein programs for operating apparatus 1, various constants, and the like, and controls the operation of each unit of apparatus 1.

It is noted that each unit constituting apparatus 1 is connected to each other via bus 12.

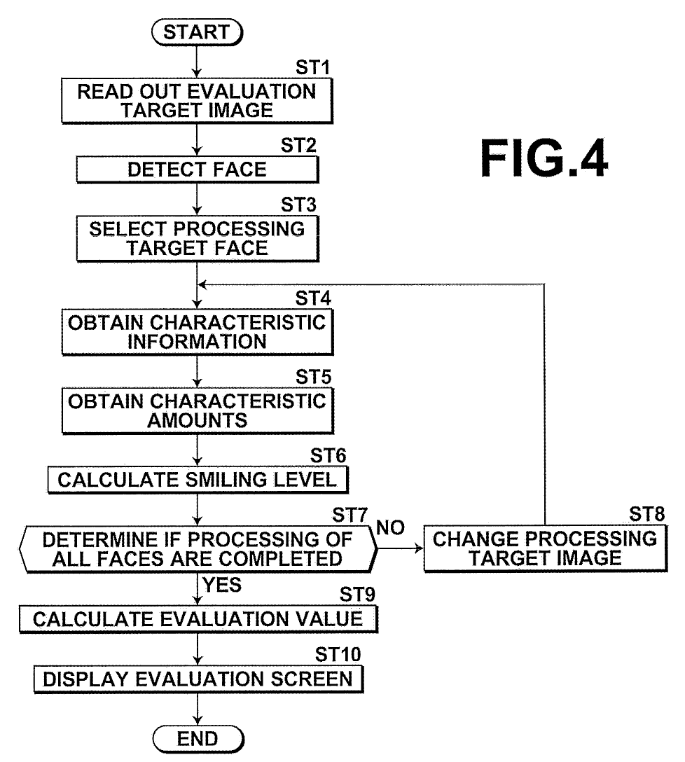

Processing performed in the first embodiment will now be described. FIG. 4 is a flowchart of the processing performed in the first embodiment. Control unit 10 starts the processing in response to an instruction to perform image evaluation inputted from input unit 5, and image input unit 2 reads out an evaluation target image from medium 2A (step ST1), and face detection unit 6 detects a face from the evaluation target image (step ST2).

Next, control unit 10 selects a first face as the processing target in the evaluation target image (step ST3). The selection order of faces included in the evaluation target image may be at random, from left to right, or in the descending order of the face size

Then, characteristic information obtaining unit 7 obtains the position, size, orientation, and inclination of the selected face (step ST4) as characteristic information C. Then, expression level calculation unit 8 obtains characteristic amounts Q of the processing target face (step ST5) and calculates smiling level S of the processing target face based on characteristic amounts Q (step ST6).

Then, control unit 10 determines whether or not the acquisition of characteristic information C and calculation of smiling levels S are completed for all of the faces included in the evaluation target image (step ST7). If step ST7 is negative, the processing target face is changed to a next face (step ST8), and the processing returns to step ST4.

If step ST7 is positive, evaluation value calculation unit 9 calculates smiling level S based evaluation value T for the evaluation target image by Formula (1) above (step ST9). Then, control unit 10 displays an evaluation screen including the evaluation target image and evaluation value T on display unit 4 (step ST10), and the processing is terminated. It is noted that an arrangement may be adopted in which evaluation value T is described in the header of the image file of the evaluation target image.

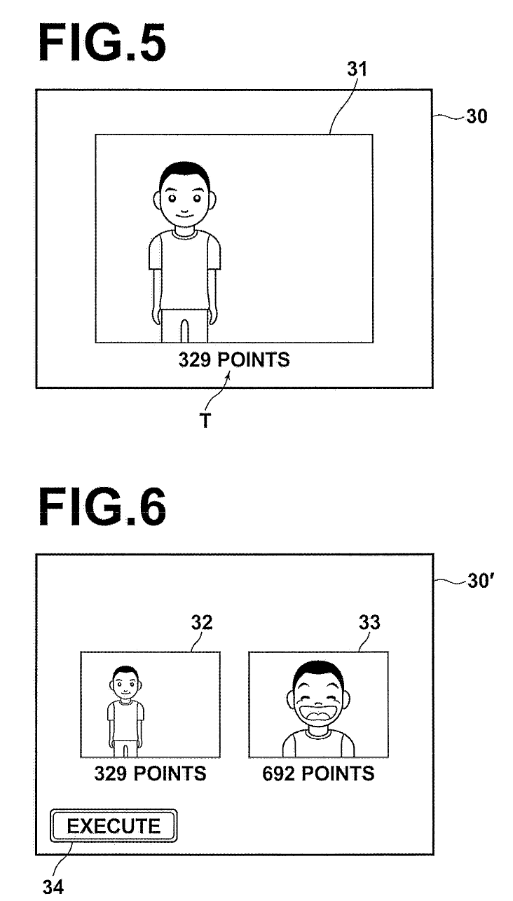

FIG. 5 illustrates the evaluation screen in the first embodiment. As illustrated in FIG. 5, evaluation target image 31 and evaluation value T thereof is displayed on evaluation screen 30.

As described above, in the first embodiment, evaluation value T, which is based on smiling level S of each face included in the evaluation target image, is calculated. This allows the superiority of the image, not the superiority of the face included in the image, to be determined easily.

Here, as alternative evaluation screen 30′ illustrated in FIG. 6, by displaying two evaluation target images 32 and 33 on display unit 4 and depressing execution button 34 for performing evaluation, thereby calculating and displaying evaluation values T of two evaluation target images 32 and 33, evaluation values T of two evaluation target images 32 and 33 may be compared. Further, by replacing evaluation target image 32 with another evaluation target image and depressing execution button 34 again, evaluation values T of evaluation target image 33 and the another evaluation target image may be compared. Then, by repeating the operation, which of the images recorded in medium 2A has a highest smiling level S-based evaluation value may be determined easily.

A second embodiment of the present invention will now be described. The image evaluation apparatus according to the second embodiment has the same configuration as the image evaluation apparatus according to the first embodiment, and differs only in the processing performed, so that the configuration will not elaborated upon further here. The image evaluation apparatus according to the second embodiment differs from the image evaluation apparatus according to the first embodiment in that it performs evaluations for a plurality of images.

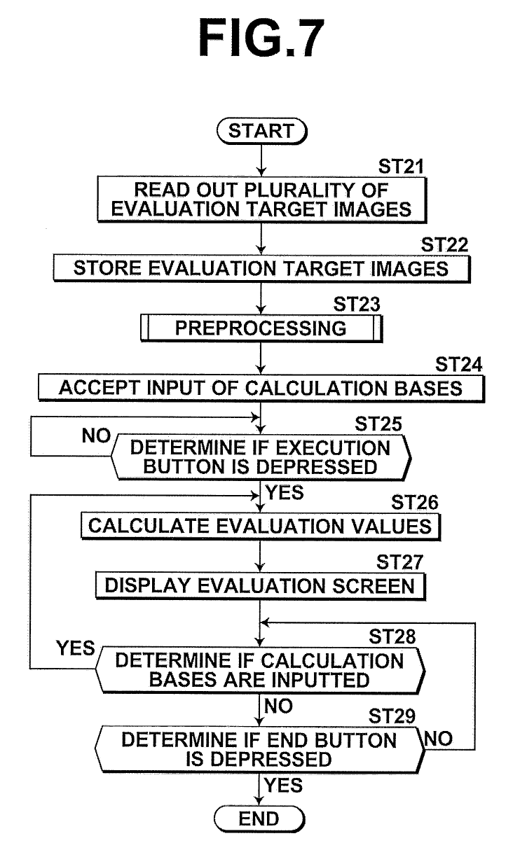

Next, the processing performed in the second embodiment will be described. FIG. 7 is a flowchart of the processing performed in the second embodiment. Control unit 10 starts the processing in response to an instruction to perform evaluations for a plurality of images inputted from input unit 5, and image input unit 2 reads out the plurality of evaluation target images from medium 2A (step ST21) and stores them in database DB1 provided in storage unit 11 (step ST22). Alternatively, image files of the evaluation target images may simply be stored in storage unit 11, instead of storing the images in image database DB1. Then, control unit 10 performs preprocessing (step ST23).

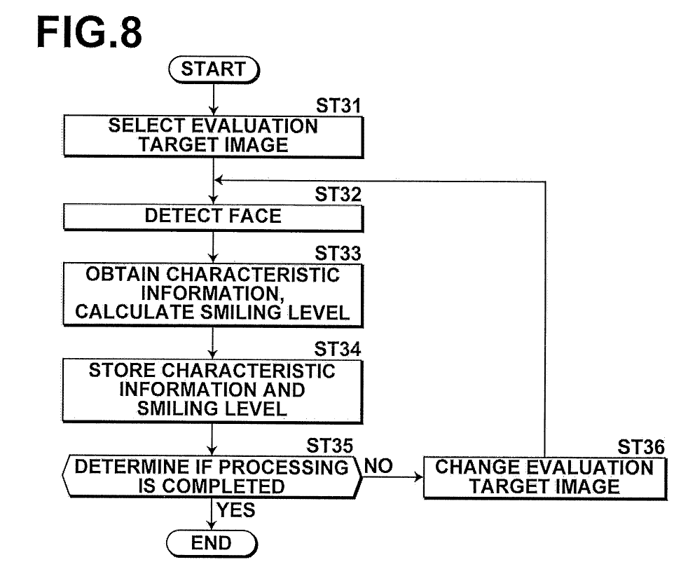

FIG. 8 is a flowchart of the preprocessing. First, control unit 10 selects a first evaluation target image (step ST31). The selection order of the evaluation target images may be in the order of file name, in the order of the date and time of imaging, or at random.

Then, face detection unit 6 detects a face from the evaluation target image (step ST32) and, as in the first embodiment, characteristic information obtaining unit 7 and expression level calculation unit 8 calculate characteristic information C and smiling level S for all of the faces included in the evaluation target image (step ST33). Then, control unit 10 stores characteristic information C and smiling levels S of each evaluation target image in face information database DB2 associated with corresponding evaluation target image (step ST34). It is noted that face information database DB2 is provided in storage unit 11.

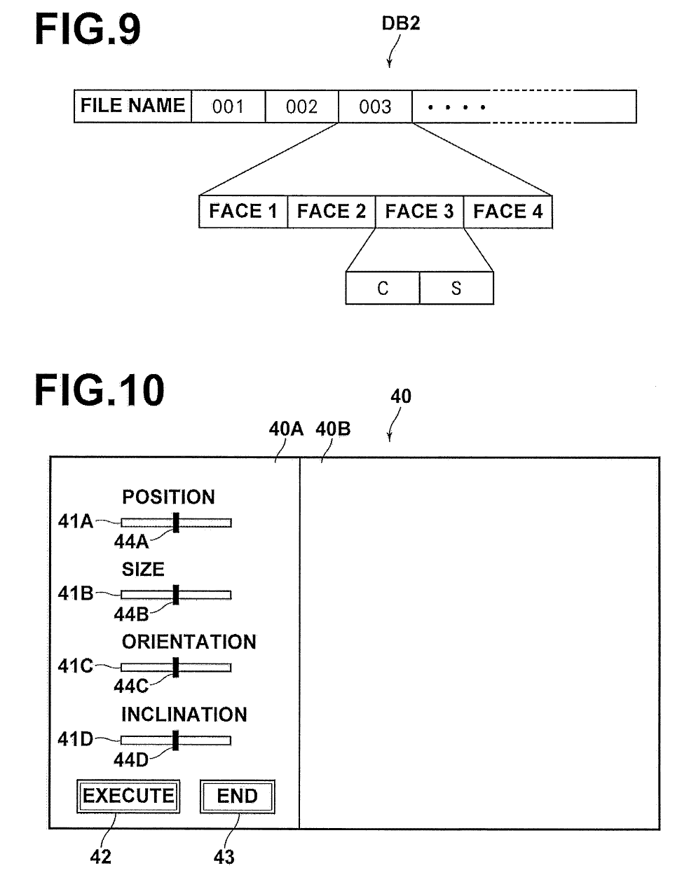

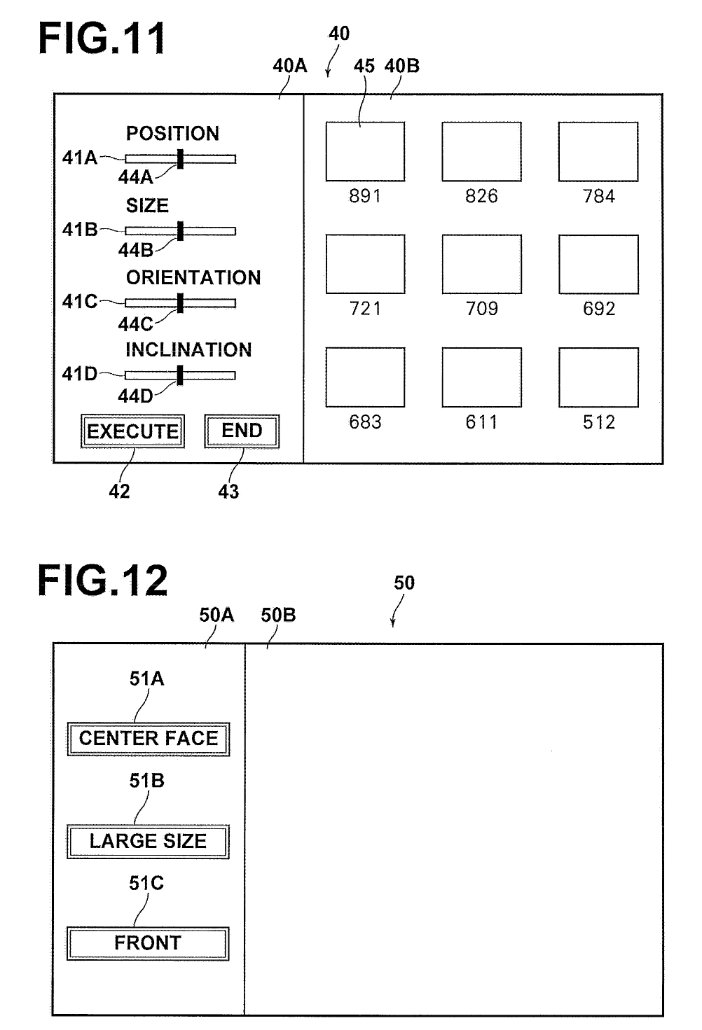

FIG. 9 illustrates the configuration of face information database DB2. As shown in FIG. 9, file names of the evaluation target images are registered in face information database DB2, and characteristic information C and smiling levels S corresponding to the number of faces included in each evaluation target image are registered under each file name. FIG. 9 shows a case in which four faces (faces 1 to 4) are included in the evaluation target image with the file name 003 and characteristic information C and smiling level S of face 3 of the four faces are registered.

Then, control unit 10 determines whether or not the acquisition of characteristic information C and calculation of smiling levels S are completed for all of the readout evaluation target images (step ST35). If step ST35 is negative, the evaluation target image is changed to a next image (step ST36), and the processing returns to step ST32. If step ST35 is positive, the preprocessing is terminated.

Now returning to FIG. 7, control unit 10 accepts input of calculation bases for evaluation value T of the evaluation target image following the preprocessing (step ST24). FIG. 10 illustrates an evaluation screen for inputting the calculation bases. As shown in FIG. 10, evaluation screen 40 includes instruction area 40A on the left and image display area 40B on the right. Instruction area 40A includes instruction bars 41A to 41D for changing weighting factors W1 to W4 of face position, size, orientation, and inclination respectively, execution button 42 for implementing evaluation, and end button 43 for terminating the evaluation. Instruction bars 41A to 41D include levers 44A to 44D and the user may move levers 44A to 44D in the left or right via input unit 5 to change weighting factors W1 to W4.

The user may input calculation bases to the apparatus 1 by operating levers 44A to 44D of instruction bars 41A to 41D and changing weighting factors W1 to W4 of the position, size, orientation, and inclination of the face included in characteristic information C on evaluation screen 40. Image display area 40B is the area for displaying thumbnail images of the evaluation target images as described later.

Next, control unit 10 start monitoring whether or not execution button 42 is depressed (step ST25). If step ST25 is positive, evaluation value calculation unit 9 obtains characteristic information C and smiling levels of all of the evaluation target images by referring to face information database DB2. Then, the evaluation value calculation unit 9 calculates weighting factors P by Formula (2) above using the instructed calculation bases, that is, instructed weighting factors W1 to W4, and evaluation values T by Formula (1) above for all of the evaluation target images (step ST26).

Then, control unit 10 displays an evaluation screen on which thumbnail images of the evaluation target images with the evaluation results arranged in the descending order of evaluation value T are displayed (step ST27).

Next, control unit 10 determines whether or not calculation bases are inputted (step ST28), and if step ST28 is positive, the processing returns to step ST26 to calculate evaluation values T using inputted new calculation conditions. The calculation of evaluation values T using the new calculation conditions differ from the previous calculation thereof in weighting factors W1 to W4 of characteristic information C, so that the results differ from the previous ones. On the other hand, if step ST28 is negative, control unit 10 determines whether or not end button 43 is depressed (step ST29) and if step ST29 is negative, the processing returns to step ST28, while if step ST28 is positive, the processing is terminated.

As described above, in the second embodiment, input of calculation bases is accepted, and evaluation values T are calculated with the inputted calculation bases. This allows calculation of evaluation values T according to image evaluation bases desired by the user.

Further, as shown in FIG. 10, the user may cause the apparatus 1 to calculate image evaluation values T according to the characteristic information desired by the user by changing weighting factors W1 to W4 of the face position, size, orientation, and inclination using instruction bars 41A to 41D.

Still further, thumbnail images of a plurality of evaluation target images are displayed arranged in descending order of evaluation value T so that the evaluation results of the plurality of image may be checked easily.

In the second embodiment, thumbnail images of evaluation target images and evaluation values T thereof are displayed in image display area 40B of evaluation screen 40, but the attribute information, such as file names of the images and the like, may also be displayed.

Further, in the second embodiment, instruction area 40A is provided and calculation bases are inputted by operating levers 44A to 44D of instruction bars 41A to 41D. But, as evaluation screen 50 shown in FIG. 12, center face button 51A which is to be depressed when an image with a face located in the center is desired to be ranked high in the evaluation, large size button 51B which is to be depressed when an image with a large face is desired to be ranked high in the evaluation, and front button 51C which is to be depressed when an image with a face oriented in the front direction is desired to be ranked high in the evaluation may be provided in instruction area 50A, thereby allowing input of a calculation basis by depressing either one of buttons 51A to 51C.

In this case, each of buttons 51A to 51C is associated with a value of each of weighting factors W1 to W4. For example, a large value of weighting factor W1 is associated with center face button 51A, a large value of weighting factor W2 is associated with large size button 51B, and a large value of weighting factor W3 is associated with front button 51C.

When the user inputs a calculation basis by depressing a desired one of buttons 51A to 51C, weighting factor P is calculated with one of weighting factors W1 to W4 according to the depressed button and evaluation value T is calculated. This allows the user to cause apparatus 1 to calculate an image evaluation value weighted in the desired face characteristic without giving detailed instructions.

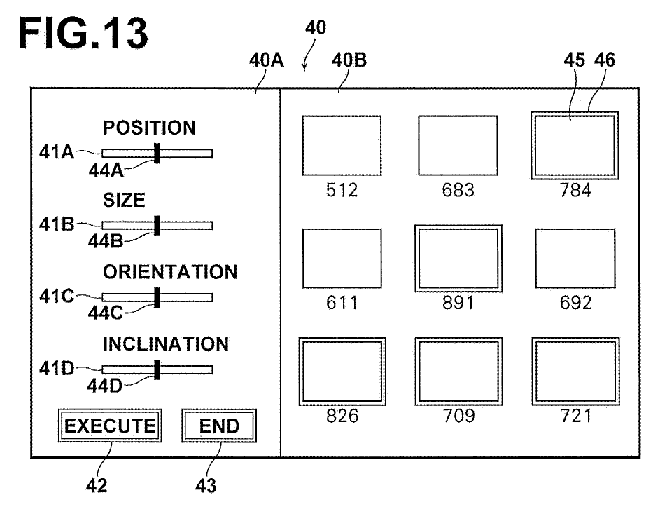

Further, in the second embodiment, thumbnail images of the evaluation target images are displayed arranged in descending order of evaluation value T. Alternatively, the thumbnail images may be displayed arranged in the order of the file name with evaluation values T attached thereto. Still further, as illustrated in FIG. 13, frame 46 may be added to thumbnail image 45 with evaluation value T greater than or equal to a predetermined value. FIG. 13 shows a case in which frames 46 are added to thumbnail images 45 with evaluation values T exceeding 700 points. This allows images having high evaluation values T to be recognized easily.

Still further, in the second embodiment, characteristic information C and smiling levels are stored in face information database DB2. But, an arrangement may be adopted in which points R1 to R4 with respect to characteristic information, that is, the face position, size, orientation, and inclination are calculated, and points R1 to R4 corresponding to characteristic information C and smiling levels S are stored in face information database DB2. This eliminates the need to calculate points R1 to R4 when calculating evaluation value T, so that evaluation value T may be calculated more quickly.

Further, in the first embodiment, evaluation value T is calculated with predetermined weighting factors W1 to W4, but an arrangement may be adopted in which input of calculation bases is accepted and evaluation value T is calculated by weighting face characteristics desired by the user as in the second embodiment.

Still further, in the first and second embodiments, smiling level S-based evaluation value T for the evaluation target image is calculated. But, evaluation value T may be calculated according to the level of other face expressions, such as crying face, angry face, serious face, surprised face, and the like. In this case, expression level calculation unit 8 calculates an expression level of a predetermined type of expression.

Further, in the first and second embodiments, face position, size, orientation, and inclination are obtained as characteristic information C, but only at least two of the face position, size, orientation, and inclination, in particular, face position and size are required as characteristic information C. The evaluation target image may sometimes become vertically long or inverted depending on the way of hold the camera. Therefore, it may sometimes be desirable not to include face inclination in characteristic information C to calculate evaluation value T.

So far apparatus 10 according to the first embodiment of the present invention has been described, but a program for causing a computer to function as units corresponding to face detection unit 6, characteristic information obtaining unit 7, expression level calculation unit 8, and evaluation value calculation unit 9, and to perform processing like that shown in FIGS. 4, 7, and 8 is another embodiment of the present invention. Further, a computer readable recording medium on which is recorded such a program is still another embodiment of the present invention.

What is claimed is:

1. An image evaluation apparatus, comprising
a face detection unit for detecting, from an image including at least one face, each of the at least one face;
a characteristic information obtaining unit for obtaining a plurality of characteristic information representing characteristics of each face;
an expression level calculation unit for calculating an expression level representing the level of a specific expression of each face; and
an evaluation value calculation unit for calculating an expression-based evaluation value for the image based on the characteristic information and the expression level of each face.

2. The image evaluation apparatus as claimed in claim 1, wherein the evaluation value calculation unit is a unit for calculating the evaluation value by performing a weighted addition of the expression level of each face with a weighting factor determined based on the characteristic information corresponding to each face.

3. The image evaluation apparatus as claimed in claim 1, wherein:
the apparatus further comprises an input unit for accepting input of a calculation basis for the evaluation value; and
the evaluation value calculation unit is a unit for calculating the evaluation value using the inputted calculation basis.

4. The image evaluation apparatus as claimed in claim 2, wherein:
the apparatus further comprises an input unit for accepting input of a calculation basis for the evaluation value; and
the evaluation value calculation unit is a unit for calculating the evaluation value using the inputted calculation basis.

5. The image evaluation apparatus as claimed in claim 4, wherein, when the weighting factor is a factor obtained by a weighted addition of evaluation points determined based on the plurality of characteristic information of each face with point weighting factors for weighting the evaluation points:
the input unit is a unit for accepting the calculation basis by accepting an instruction to change a point weighting factor; and
the evaluation value calculation unit is a unit for calculating the evaluation value by calculating the weighting factor with the changed point weighting factor.

6. The image evaluation apparatus as claimed in claim 1, wherein, when the image is provided in a plurality and evaluation values are calculated for the plurality of images, the apparatus further comprises a display unit for displaying an evaluation screen showing evaluation results according to the magnitude of the evaluation value of each image.

7. The image evaluation apparatus as claimed in claim 3, wherein, when the image is provided in a plurality and evaluation values are calculated for the plurality of images, the apparatus further comprises a display unit for displaying an evaluation screen showing evaluation results according to the magnitude of the evaluation value of each image calculated with the inputted calculation basis.

8. An image evaluation method, comprising the steps of:
detecting, from an image including at least one face, each of the at least one face;
obtaining a plurality of characteristic information representing characteristics of each face;
calculating an expression level representing the level of a specific expression of each face; and
calculating an expression-based evaluation value for the image based on the characteristic information and the expression level of each face.

9. A computer readable recording medium on which is recorded a program for causing a computer to execute an image evaluation method, the method comprising the steps of:
detecting, from an image including at least one face, each of the at least one face;
obtaining a plurality of characteristic information representing characteristics of each face;
calculating an expression level representing the level of a specific expression of each face; and
calculating an expression-based evaluation value for the image based on the characteristic information and the expression level of each face.
